(19) United States
(12) Patent Application Publication
(10) Pub. No.: US 2018/0187949 A1
(43) Pub. Date: Jul. 5, 2018

(54) REFRIGERATOR

(71) Applicant: QINGDAO HAIGAO DESIGN & MANUFACTURING CO., LTD, Qingdao, Shandong (CN)

(72) Inventors: Jian WU, Qingdao (CN); Zhaojun FEI, Qingdao (CN); Shu ZHOU, Qingdao (CN); Nanhai DAI, Qingdao (CN); Zhiqun FENG, Qingdao (CN); Yali QI, Qingdao (CN)

(21) Appl. No.: 15/741,155

(22) PCT Filed: Jun. 24, 2016
(86) PCT No.: PCT/CN2016/087070

§ 371 Date: Dec. 29, 2017

(30) Foreign Application Priority Data
Jun. 30, 2015 (CN) 201510373823.3

(51) Int. Cl. F25D 23/02; E05D 15/06

(52) U.S. Cl. CPC F25D 23/021; E05Y 2900/31; F25D 23/025; E05D 15/0621

(57) ABSTRACT

A refrigerator comprises a case defining a storage compartment, and at least one door assembly. Each door assembly comprises: a door, arranged in front of the case and used for opening or closing the storage compartment; and a translation means, arranged on the top of the case. The translation means comprises: a lateral slider, directly or indirectly mounted on the case and capable of moving relative to the case along a lateral direction of the case; and a longitudinal slider, mounted on the lateral slider and capable of moving relative to the lateral slider along a front-and-rear direction of the case. The door is fixed on the longitudinal slider to translate with the longitudinal slider along the front-and-rear direction of the case and translate with the lateral slider along the lateral direction of the case, so as to open or close the storage compartment.

### TECHNICAL FIELD

The present invention relates to a refrigeration apparatus, in particular to a refrigerator.

### BACKGROUND OF THE INVENTION

The existing refrigerator door is generally pivotally mounted to the front of a case, and is opened or closed by rotating around the axis of rotation of a lateral end of the refrigerator door. However, such a rotatably-mounted door requires sufficient clearance space for door opening in front of the refrigerator, which restricts a user's selection of an area where the refrigerator is to be placed. Moreover, when opening the door, the user needs to move backwards to make a space for the door, which is rather inconvenient. In addition, a common rotatably-mounted door can only open up to about 90°, which causes inconvenient access to the interior of the refrigerator.

### SUMMARY OF THE INVENTION

The purpose of the present invention is to provide a refrigerator to solve one of the above-mentioned defects existing in the prior art.

Specifically, the present invention provides a refrigerator, which comprises a case defining a storage compartment, and at least one door assembly, characterized in that each door assembly comprises: a door provided in front of the case and used for opening or closing the storage compartment; and a translation device provided at the top of the case, the translation device comprising: a lateral slider directly or indirectly mounted on the case and capable of moving relative to the case in a lateral direction of the case, and a longitudinal slider mounted on the lateral slider and capable of moving relative to the lateral slider in a front-and-rear direction of the case, wherein the door is fixed to the longitudinal slider to translate with the longitudinal slider in the front-and-rear direction of the case and translate with the lateral slider in the lateral direction of the case, so as to open or close the storage compartment.

Optionally, each door assembly further comprises: a guide device having a base plate extending in a lateral direction, with the guide device being provided on the case via the base plate, and the lateral slider being movably mounted to the guide device.

Optionally, the base plate of the guide device is provided with a first guide groove recessed towards the case and extending in the lateral direction; and the lateral slider is provided with at least one first guide member disposed in the first guide groove and cooperating with the first guide groove, so that the lateral slider is only movable in the lateral direction.

Optionally, the first guide member is a first guide wheel, of which the axis of rotation extends in a vertical direction.

Optionally, the guide device further comprises two flanges respectively to extending from front and rear ends of the base plate towards the direction away from the case, each flange forming a mounting groove extending in the lateral direction and opening towards the other flange; and front and rear ends of the lateral slider are respectively provided with a plurality of first rollers, and the lateral slider is movably mounted to the corresponding mounting groove via the plurality of first rollers.

Optionally, the lateral slider is formed with at least one second guide groove recessed towards the case and extending in a front-and-rear direction; and the longitudinal slider is provided with at least one second guide member disposed in the second guide groove and cooperating with the second guide groove, so that the longitudinal slider is only movable in the front-and-rear direction.

Optionally, the second guide member is a second guide wheel, of which the axis of rotation extends in a vertical direction.

Optionally, the lateral slider is provided with a plurality of second mounting grooves extending in the front-and-rear direction and opening towards the lateral direction, the plurality of second mounting grooves being arranged at intervals in the lateral direction, wherein opening directions of two adjacent second mounting grooves are opposite; and the longitudinal slider is provided with a plurality of second roller sets, of which the axes of rotation are arranged at intervals in the lateral direction, each second roller set comprises a plurality of second rollers arranged in the front-and-rear direction, and the second roller set is provided in the second mounting groove, so that the longitudinal slider can be movably mounted to the lateral slider in the front-and-rear direction of the case relative to the lateral slider.

Optionally, the base plate of the guide device is further provided with a third guide groove for guiding the movement of the longitudinal slider, the third guide groove comprising a first section extending forwards from the rear of the base plate at a first pre-set distance from a lateral end of the base plate, and a second section extending in the lateral direction from the tail end of the first section towards the direction away from lateral end;

the longitudinal slider is provided with a third guide member, which is movably disposed in the third guide groove and is configured to enable the longitudinal slider to move along the third guide groove when the lateral slider moves laterally; when moving backwards in the first section, the third guide member enables the door fixed to the longitudinal slider to move to and abut against the front of the case, such that the door is attached to the front of the case to close the storage compartment, and when moving forwards in the first section, the third guide member enables the door to move forwards gradually away from the front of the case; and when the third guide member moves laterally in the second section, the door moves laterally with the longitudinal slider to open the storage compartment.

Optionally, the third guide member is a third guide wheel, of which the axis of rotation extends in a vertical direction.

Optionally, each door assembly further comprises a further translation device provided at the bottom of the case.

Optionally, the number of the at least one door assembly is two, lateral sliders of the two door assemblies are arranged side by side at the top of the case in the lateral direction, and the translation devices of the two door assemblies are configured as:

when closing the storage compartment, the lateral sliders of the two door assemblies move to two lateral ends at the top of the case, and longitudinal sliders of the two door assemblies move backwards on the corresponding lateral sliders until doors fixed to the longitudinal sliders abut against the front of the case, such that the doors of the two door assemblies are arranged side by side in the lateral direction in front of the case to close the storage compartment; and

when one door of the two door assemblies is opened, the longitudinal slider fixed to the one door moves forwards by a pre-set distance on the corresponding lateral slider so that the one door is at the pre-set distance from the front of the case, and the lateral slider corresponding to the one door moves towards the other lateral slider in the lateral direction of the case, such that the one door is at least partially in front of the other door to open the storage compartment.

In the refrigerator of the present invention, the door is mounted to the case via the translation device, such that the door can open or close the storage compartment in translational movement, and comparing same with the existing rotary door, there is no need to reserve a clearance space for door opening in front of the refrigerator, and the user does not need to move backwards to make a space for opening the door, which is quite convenient.

Furthermore, the refrigerator of the present invention can be provided with two doors, and when one door is opened, the one door can move forwards by a pre-set distance and then move towards the other door and finally is located in front of the other door, and therefore, there is no need to reserve a clearance space for door opening on two lateral sides of the refrigerator.

According to the detailed description of the particular embodiments of the present invention below in conjunction with the accompanying drawings, the above-mentioned and other objects, advantages and features of the present invention will be clearer to a person skilled in the art.

### BRIEF DESCRIPTION OF THE DRAWINGS

Some of the particular embodiments of the present invention will be described below in detail in an exemplary but not limiting way with reference to the accompanying drawings. The same reference signs in the figures indicate the same or similar components or parts. A person skilled in the art should understand that these figures are not necessarily drawn to scale. In the accompanying drawings:

FIG. 1 is a schematic exploded view of a refrigerator according to one embodiment of the present invention;

FIG. 2 is a schematic enlarged view of a guide device in the refrigerator as shown in FIG. 1;

FIG. 3 is a schematic view of a lateral slider in the refrigerator as shown in FIG. 1,

FIG. 4 is a schematic bottom view of the lateral slider as shown in FIG. 3;

FIG. 5 is a schematic bottom view of a longitudinal slider in the refrigerator as shown in FIG. 1;

FIG. 6 is a schematic view of the refrigerator as shown in FIG. 1, with doors in a closed state; and

FIG. 7 is a schematic view of the refrigerator as shown in FIG. 1, with one door in an opening state.

### DETAILED DESCRIPTION OF THE INVENTION

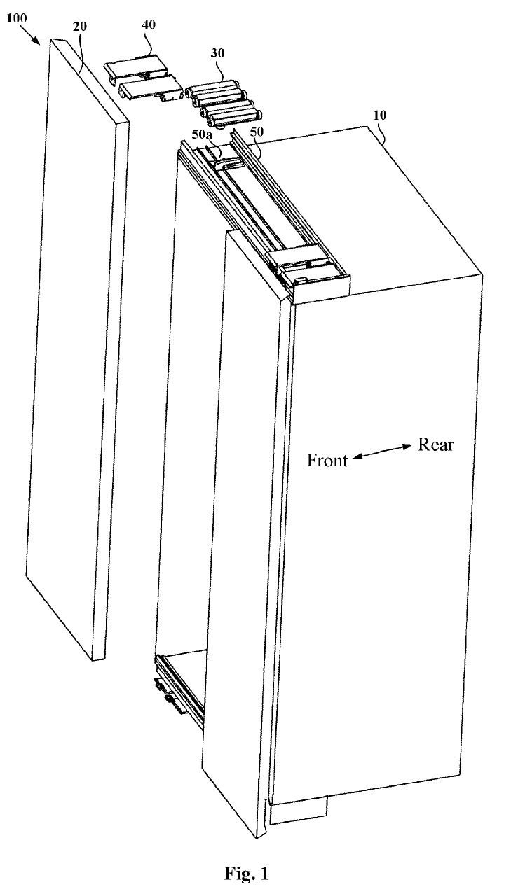

FIG. 1 is a schematic exploded view of a refrigerator according to one embodiment of the present invention. As shown in FIG. 1, a refrigerator 100 comprises a case 10 and a door assembly. The case 10 defines a storage compartment for placing articles. The door assembly comprises a door 20, and a translation device provided at the top of the case 10, wherein the door 20 is provided in front of the case 10 to open or close the storage compartment, and the translation device is used for mounting the door 20 to the case 10. The translation device comprises a lateral slider 30 and a longitudinal slider 40, wherein the lateral slider 30 is directly or indirectly mounted to the case 10 and is capable of moving relative to the case 10 in a lateral direction (i.e. a left-and-right direction) of the case 10, and a longitudinal slider 40 is mounted on the lateral slider 30 and is capable of moving relative to the lateral slider 30 in a front-and-rear direction of the case 10. The door 20 is fixed to the longitudinal slider 40, such that the door can translate with the longitudinal slider 40 in the front-and-rear direction of the case 10 and translate with the lateral slider 30 in the lateral direction of the case 10, so as to open or close the storage compartment.

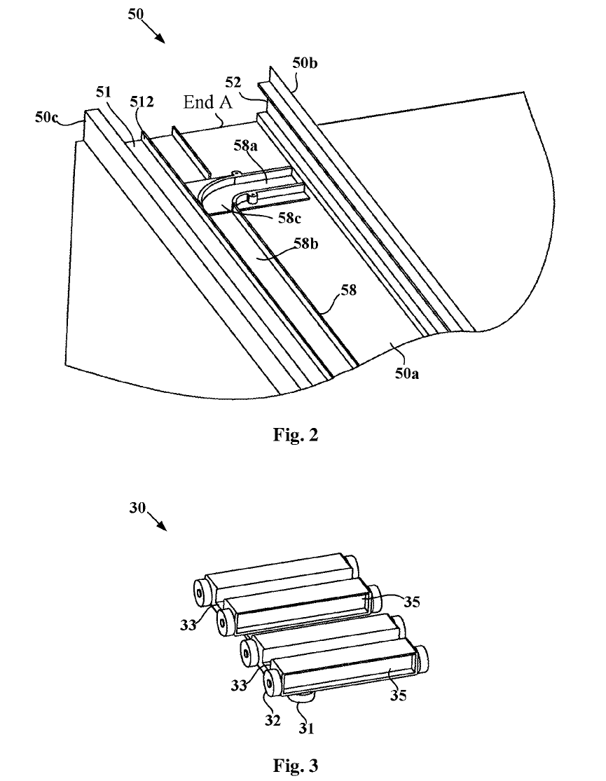

FIG. 2 is a schematic enlarged view of a guide device in the refrigerator as shown in FIG. 1. In conjunction with FIG. 1 and FIG. 2, in a preferred embodiment, the translation device is indirectly rather than directly mounted on the case 10. In particular, each door assembly comprises a guide device 50 provided on the case 10, wherein the guide device 50 has a base plate 50a extending in the lateral direction and is fixedly mounted to the front of the top of the case 10, and the lateral slider 30 is movably mounted to the guide device 50. The guide device 50 is used to guide the movement direction of the lateral slider 30.

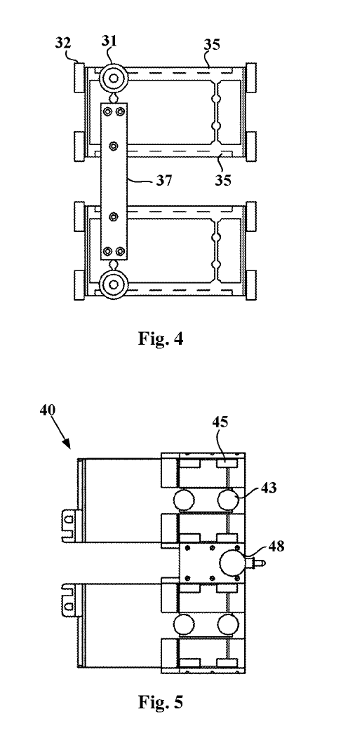

FIG. 3 is a schematic view of the lateral slider 30 in the refrigerator as shown in FIG. 1, and FIG. 4 is a schematic bottom view of the lateral slider 30 as shown in FIG. 3. As shown in FIG. 1 to FIG. 4, the base plate 50a of the guide device 50 is provided with a first guide groove 51 recessed towards the case 10 and extending in the lateral direction; and correspondingly, the lateral slider 30 is provided with at least one first guide member 31 disposed in the first guide groove 51 and cooperating with the first guide groove 51. Since the first guide member 31 is only movable in the lateral direction in the first guide groove 51, the lateral slider 30 can only move in the lateral direction, i.e. limiting degrees of freedom of the lateral slider 30 in the front-and-rear direction.

In particular, as shown in FIG. 2, the first guide groove 51 comprises a bottom wall and two side walls 512 (a further side wall is invisible because of being blocked in the figure) perpendicular to the base plate 50a, and is preferably provided in the front of the base plate 50a. Correspondingly, the first guide member 31 is a first guide wheel, of which the axis of rotation is perpendicular to the bottom wall, so that the first guide wheel can only roll on one of the side walls. As shown in FIG. 3 and FIG. 4, in the particular implementation process, the lateral slider 30 is formed by two mutually symmetric halves, and the two halves are fixed together via a connector 37. Each half is provided with one first guide wheel, and when the lateral slider 30 is mounted to the guide device 50, two first guide wheels may roll on one side wall of the first guide groove 51, such that degrees of freedom of the lateral slider 30 in the front-and-rear direction are completely limited and can only move in the lateral direction.

As previously mentioned, the lateral slider 30 is movably mounted to the guide device 50. In general, a part of the lateral slider 30 can directly slide on the surface of the guide device 50, that is, the two is connected in a sliding friction manner. A preferred solution is to enable the lateral slider 30 to be connected to the guide device 50 in a rolling friction manner. In particular, the guide device 50 comprises two flanges (flange 50b and flange 50c) respectively bending from front and rear ends of the base plate 50a towards the direction away from the case 10, each flange forming a mounting groove 52 extending in the lateral direction and opening towards the other flange. That is, openings of two mounting grooves 52 are arranged oppositely. Correspondingly, front and rear ends of the lateral slider 30 are respectively provided with a plurality of first rollers 32. As shown in FIG. 3 and FIG. 4, front and rear ends of each half of the lateral slider 30 are respectively provided with two first rollers 32, and the lateral slider 30 is movably mounted to the corresponding mounting groove 52 via the plurality of first rollers 32, thus being labour-saving in lateral movement.

FIG. 5 is a schematic bottom view of the longitudinal slider 40 in the refrigerator as shown in FIG. 1. In conjunction with FIG. 1, FIG. 3 and FIG. 5, the lateral slider 30 is formed with at least one second guide groove 33 recessed towards the case 10 and extending in the front-and-rear direction, such as being able to provide one second guide groove 33 on each half of the lateral slider. Correspondingly, the longitudinal slider 40 is provided with at least one second guide member 43 disposed in the second guide groove 33 and cooperating with the second guide groove 33, so that the longitudinal slider 40 is only movable in the front-and-rear direction. The specific structure of the longitudinal slider 40 is given with reference to FIG. 5, and comprises two mutually symmetric halves, each half being provided with two second guide members 43. In order to reduce friction, the second guide member 43 is a second guide wheel, of which the axis of rotation extends in a vertical direction. When the longitudinal slider 40 is mounted to the lateral slider 30, the second guide wheel is in the second guide groove 33 disposed in the front-and-rear direction and rolls on the side wall of the second guide groove 33, such that the longitudinal slider 40 can only move in the front-and-rear direction relative to the lateral slider 30.

Similar to the method of mounting the lateral slider 30 to the guide device 50, the longitudinal slider 40 is also mounted to the lateral slider 30 via a plurality of rollers, so as to enable the longitudinal slider to move relative to the lateral slider 30 in a more labour-saving manner. In particular, as shown in FIG. 3 and FIG. 4, the lateral slider 30 is provided with a plurality of second mounting grooves 35 extending in the front-and-rear direction and opening towards the lateral direction, the plurality of second mounting grooves 35 being arranged at intervals in the lateral direction, wherein opening directions of two adjacent second mounting grooves 35 are opposite. For example, two lateral ends of each half of the lateral slider 30 are respectively provided with a second mounting groove 35. Correspondingly, as shown in FIG. 5, the longitudinal slider 40 is provided with a plurality of second roller sets, of which the axes of rotation are arranged at intervals in the lateral direction, the second roller set is proved in the second mounting groove 35, and each second roller set comprises a plurality of second rollers 45 arranged in the front-and-rear direction. For example, two lateral ends of each half of the longitudinal slider 40 are respectively provided with one second roller set, and each second roller set shall comprise at least two second rollers 45, so as to maintain the stability of the movement.

It can be seen from the previous description that the movement of the longitudinal slider 40 with respect to the guide device 50 is a planar compound movement, which comprises lateral movement with the lateral slider 30 and front-and-rear movement with respect to the lateral slider 30. The lateral movement of the longitudinal slider 40 is consistent with the movement of the lateral slider 30, but the variable range of the front-and-rear movement is relatively large. Therefore, it is necessary to guide the movement of the longitudinal slider 40 so as to ensure that the movement of the longitudinal slider 40 is more controllable.

In particular, as show in FIG. 2, the base plate 50a of the guide device 50 is provided with a third guide groove 58 for guiding the movement of the longitudinal slider 40, the third guide groove comprising a first section 58a extending forwards from the rear of the base plate 50a at a first pre-set distance (e.g. 10 mm) from a lateral end (end A) of the base plate 50a, and a second section 58b extending in the lateral direction from the tail end of the first section 58a towards the direction away from lateral end (end A), and preferably, an arc transition section 58c is provided between the first section 58a and the second section 58b. Correspondingly, the longitudinal slider 40 is provided with a third guide member 48, which is movably disposed in the third guide groove 58, and when the lateral slider 30 moves laterally, the longitudinal slider 40 moves along the third guide groove 58. Preferably, the third guide member 48 is a third guide wheel, of which the axis of rotation extends in a vertical direction, and is provided in the lateral central position of two halves of the longitudinal slider 40.

When moving backwards in the first section 58a, the third guide member 48 enables the door 20 fixed to the longitudinal slider 40 to move to and abut against the front of the case 10, such that the door 20 is attached to the front of the case 10 to close the storage compartment, and when moving forwards in the first section 58a, the third guide member 48 enables the door 20 to move forwards gradually away from the front of the case 10. When the third guide member 48 moves laterally in the second section 58b, the door 20 moves laterally with the longitudinal slider 40 to open the storage compartment.

Preferably, each door assembly, apart from comprising the translation device provided at the top of the case 10, further comprises a further translation device provided at the bottom of the case 10, and the two translation devices at the top and the bottom cooperate with each other and can enhance the stability of the integral structure of the door assembly and the sealing performance of the door 20 to the case 10.

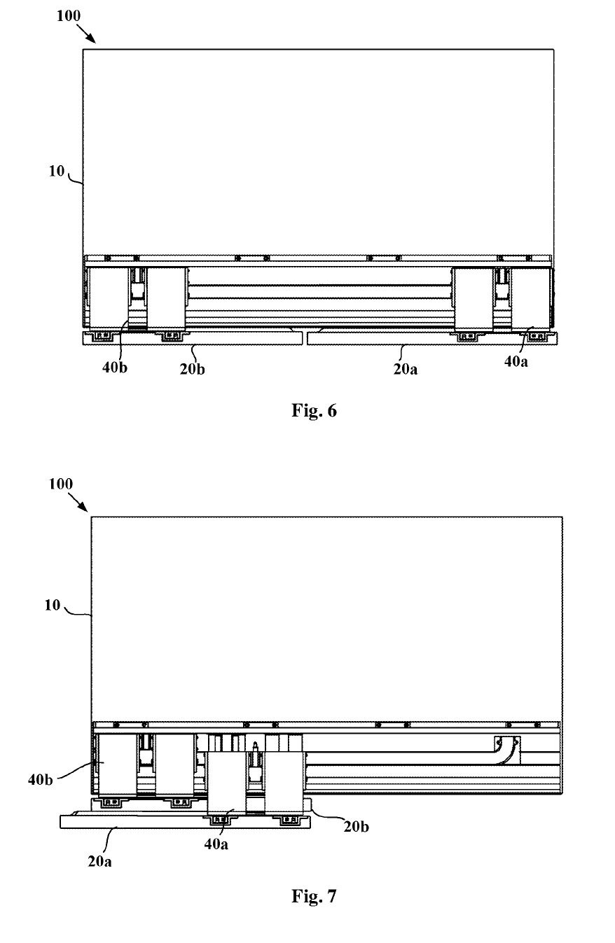

FIG. 6 and FIG. 7 schematically show the case where the technical solution of the present invention is applied to a side-by-side refrigerator, wherein FIG. 6 is a schematic view of the refrigerator as shown in FIG. 1, with doors in a closed state; and FIG. 7 is a schematic view of the refrigerator as shown in FIG. 1, with one door in an opening state. As shown in FIG. 6 and FIG. 7, the refrigerator 100 comprises two door assemblies, doors (i.e. door 20a and door 20b) of the door assemblies are arranged side by side in the lateral direction in front of the case 10.

As shown in FIG. 6, when closing the storage compartment, the lateral sliders of the two door assemblies move to two lateral ends at the top of the case 10, and longitudinal sliders (longitudinal slider 40a and longitudinal slider 40b) of the two door assemblies move backwards on the corresponding lateral sliders until doors fixed to the longitudinal sliders abut against the front of the case 10, such that the doors (door 20a and door 20b) of the two door assemblies are arranged side by side in the lateral direction in front of the case 10 to close the storage compartment.

As shown in FIG. 7, when one door of the two door assemblies is opened, for example, when opening the door 20a as shown in FIG. 7, the door 20a is pulled forwards, the longitudinal slider 40a fixed to the door moves forwards by a pre-set distance (being greater than the thickness of the door) on the corresponding lateral slider so that the door 20a is spaced at the pre-set distance mentioned previously from the front of the case 10, and the lateral slider corresponding to the door 20a moves towards the other lateral slider in the lateral direction of the case 10, such that the door 20a is at least partially in front of the other door (i.e. door 20b) to open the storage compartment. In particular, it is configured as: in the process of opening the storage compartment by the lateral movement of the door 20a, when the door 20a moves to a final state (that is, the door 20a is in a maximum opening state), the lateral slider corresponding thereto abuts against the lateral slider corresponding to the door 20b, and the door 20a is exactly in front of the door 20b, such that there is no need to reserve a clearance space for door opening on two sides of the case 10, which does not restrict a user's selection of an area where the refrigerator is to be placed.

Up to this, a person skilled in the art should recognize that although a plurality of exemplary embodiments of the present invention have been shown and described in detail herein, numerous other variations or modifications meeting the principle of the present invention can be directly determined or derived according to the contents disclosed in the present invention. Therefore, the scope of the present invention should be construed and considered as covering all of such other variations or modifications.

What is claimed is:

1. A refrigerator, comprising a case defining a storage compartment, and at least one door assembly, wherein each door assembly comprises:
a door provided in front of the case and used for opening or closing the storage compartment; and
a translation device provided at the top of the case, the translation device comprising:
a lateral slider directly or indirectly mounted on the case and capable of moving relative to the case in a lateral direction of the case, and
a longitudinal slider mounted on the lateral slider and capable of moving relative to the lateral slider in a front-and-rear direction of the case,
wherein the door is fixed to the longitudinal slider to translate with the longitudinal slider in the front-and-rear direction of the case and translate with the lateral slider in the lateral direction of the case, so as to open or close the storage compartment.

2. The refrigerator according to claim 1, wherein each door assembly further comprises:
a guide device having a base plate extending in a lateral direction, with the guide device being provided on the case via the base plate, and the lateral slider being movably mounted to the guide device.

3. The refrigerator according to claim 2, wherein
the base plate of the guide device is provided with a first guide groove recessed towards the case and extending in the lateral direction; and
the lateral slider is provided with at least one first guide member disposed in the first guide groove and cooperating with the first guide groove, such that the lateral slider is only movable in the lateral direction.

4. The refrigerator according to claim 3, wherein
the first guide member is a first guide wheel, of which an axis of rotation extends in a vertical direction.

5. The refrigerator according to claim 2, wherein
the guide device further comprises two flanges respectively extending from front and rear ends of the base plate towards a direction away from the case, each flange being formed with a mounting groove extending in the lateral direction and opening towards the other flange; and
front and rear ends of the lateral slider are respectively provided with a plurality of first rollers, and the lateral slider is movably mounted in the corresponding mounting groove via the plurality of first rollers.

6. The refrigerator according to claim 2, wherein
the lateral slider is formed with at least one second guide groove recessed towards the case and extending in a front-and-rear direction; and
the longitudinal slider is provided with at least one second guide member disposed in the second guide groove and cooperating with the second guide groove, such that the longitudinal slider is only movable in the front-and-rear direction.

7. The refrigerator according to claim 6, wherein
the second guide member is a second guide wheel, of which an axis of rotation extends in a vertical direction.

8. The refrigerator according to claim 2, wherein
the lateral slider is provided with a plurality of second mounting grooves extending in the front-and-rear direction and opening towards the lateral direction, the plurality of second mounting grooves being arranged at intervals in the lateral direction, with opening directions of every two adjacent second mounting grooves being opposite each other; and
the longitudinal slider is provided with a plurality of second roller sets, of which axes of rotation are arranged at intervals in the lateral direction, each second roller set comprises a plurality of second rollers arranged in the front-and-rear direction, and the second roller set is provided in the second mounting groove, such that the longitudinal slider can be movably mounted to the lateral slider in the front-and-rear direction of the case relative to the lateral slider.

9. The refrigerator according to claim 2, wherein
the base plate of the guide device is further provided with a third guide groove for guiding the movement of the longitudinal slider, the third guide groove comprising a first section extending forwards from the rear of the base plate at a first pre-set distance from a lateral end of the base plate, and a second section extending in the lateral direction from the tail end of the first section towards the direction away from lateral end;
the longitudinal slider is provided with a third guide member, which is movably disposed in the third guide groove and is configured to enable the longitudinal slider to move along the third guide groove when the lateral slider moves laterally; and wherein
when moving backwards in the first section, the third guide member enables the door fixed to the longitudinal slider to move to and abut against the front of the case, such that the door is attached to the front of the case to close the storage compartment, and when moving forwards in the first section, the third guide member enables the door to move forwards gradually away from the front of the case; and
when the third guide member moves laterally in the second section, the door moves laterally with the longitudinal slider to open the storage compartment.

10. The refrigerator according to claim 9, wherein
the third guide member is a third guide wheel, of which an axis of rotation extends in a vertical direction.

11. The refrigerator according to claim 1, wherein
each door assembly further comprises a further translation device provided at the bottom of the case.

12. The refrigerator according to claim 1, wherein
the number of the at least one door assembly is two, lateral sliders of the two door assemblies are arranged side by side at the top of the case in the lateral direction, and the translation devices of the two door assemblies are configured as follows:
when closing the storage compartment, the lateral sliders of the two door assemblies move to two lateral ends at the top of the case, and longitudinal sliders of the two door assemblies move backwards on the corresponding lateral sliders until doors fixed to the longitudinal sliders abut against the front of the case, such that the doors of the two door assemblies are arranged side by side in the lateral direction in front of the case to close the storage compartment; and
when one door of the two door assemblies is opened, the longitudinal slider fixed to the door moves forwards by a pre-set distance on the corresponding lateral slider such that the one door is at the pre-set distance from the front of the case, and the lateral slider corresponding to the one door moves towards the other lateral slider in the lateral direction of the case, such that the one door is at least partially in front of the other door to open the storage compartment.
